(19) United States
(12) Patent Application Publication
(10) Pub. No.: US 2020/0104940 A1
(43) Pub. Date: Apr. 2, 2020

(54) ARTIFICIAL INTELLIGENCE ENABLED ASSESSMENT OF DAMAGE TO AUTOMOBILES

(71) Applicants: Ramanathan Krishnan, Oakton, VA (US); John Domenech, Big Pine Key, FL (US)

(72) Inventors: Ramanathan Krishnan, Oakton, VA (US); John Domenech, Big Pine Key, FL (US)

(21) Appl. No.: 16/587,934

(22) Filed: Sep. 30, 2019

Related U.S. Application Data
(60) Provisional application No. 62/739,739, filed on Oct. 1, 2018.

(51) Int. Cl. G06Q 40/08; G06N 3/04; G06N 3/08

(52) U.S. Cl. CPC G06Q 40/08; G06N 3/088; G06N 3/04

(57) ABSTRACT

A vehicle damage assessment system is described. The system receives one or more photos in connection with a distinguished vehicle insurance claim. For each received photo, the system: uses a statistical model to identify a portion of the vehicle shown in the identified region; applies to the photo one of a number of content-based retrieval systems that is specific to the identified vehicle portion to retrieve one or more similar photos submitted with resolved claims that show the identified region of a vehicle that is the subject of the claim; and, for each retrieved photo, accesses a quantitative measure describing repair work performed under the resolved claim with which the retrieved photo was submitted. The system aggregates some or all of the accessed quantitative measures to obtain a quantitative measure predicted for the distinguished claim. The system outputs the obtained quantitative measure predicted for the distinguished claim.

### CROSS-REFERENCE TO RELATED APPLICATIONS

This Application claims the benefit of U.S. Provisional Patent Application No. 62/739,739, filed Oct. 1, 2018 and entitled “ARTIFICIAL INTELLIGENCE (AI)-ENABLED ASSESSMENT OF CAR DAMAGE,” which is hereby incorporated by reference in its entirety.

In cases where the present application conflicts with a document incorporated by reference, the present application controls.

### BACKGROUND

Conventional settlement of automobile damage insurance claims usually takes anywhere between 15 and 45 days. A damaged car is taken to a mechanic for an initial damage estimate before filing the claim. The insurer then assigns assessors to do a manual inspection of the vehicle to assess the damage and process the claim.

### BRIEF DESCRIPTION OF THE DRAWINGS

FIG. 1 is a data flow diagram showing data flow for the system's first stage in which the system uses a neural network to classify images of the damaged car as each portraying a particular region of the car.

FIG. 2 is a data flow diagram showing data flow for the system's second stage in which the system uses CBIR tools trained by the system to analyze damage to each region by matching it to sample damage of known magnitude and cost to the same region of other cars.

FIG. 3 is a data flow diagram illustrating a process performed by the system in some embodiments to perform car region classification for car images.

FIG. 4 is a flow diagram showing process performed by the system in some embodiments to perform region classification.

FIG. 5 is a data flow diagram showing the system's application of deep autoencoders in some embodiments.

FIG. 6 is a data flow diagram showing the system's retrieval in some embodiments of matching car images using a CBIR tool.

FIG. 7 is a block diagram showing some of the components typically incorporated in at least some of the computer systems and other devices on which the system operates.

### DETAILED DESCRIPTION

The inventors have identified significant shortcomings of conventional car damage claim processes. They have determined that conventional damage insurance claim filing and processing are tedious, and often frustrating for car insurance holders. Manual, in-person inspection of cars is time-consuming. There is a need to ascertain the extent of damage before getting an idea of the repair time and repair cost. This can itself delay the claims settlement process. Assessors can be biased, intentionally or unintentionally. This bears on the outcome of the claims processing. Additionally, many countries have laws that specify a maximum number of days before which the insurance claim must be accepted or denied. Hence, the inventors have determined that it is highly desirable to speed up the whole evaluation process of car insurance claim.

Accordingly, the inventors have conceived and reduced to practice an automated system that uses an AI-based model to perform loss assessment. The computational speed of the AI coupled with a reduced need for physical inspection of vehicles by assessors expedites loss assessment. This helps insurance companies process claims faster.

In traditional damage assessment systems, fraudulent claims can go undetected. For instance, if a car is damaged in a series of separate events extending over weeks or months, its owner may file a claim for the aggregate damage at a later occasion, in an effort to limit insurance premium increases. This sort of improper claim filing strategy can be detected by the AI-based system.

In some embodiments, the system uses a two-staged approach. In the first stage, the system uses a pre-trained convolutional neural network (CNN) to classify each of a number of photographs of the car as portraying a particular one of multiple regions of the car. In the second stage, the system uses content-based image retrieval (CBIR) techniques to analyze damage to each region by matching it to sample damage of known magnitude and cost to the same region of other cars.

The system compiles a database of images of damaged cars and the corresponding payouts made by the insurer to the insured, using past insurance records, and analyzes data consisting of images of damaged cars. The system estimates damage in different car regions, then aggregates it, leaving out overlaps, to assess the overall damage in the car. Thus, based on previous data, the artificial intelligence (AI)-based model can help the insurer and the insured predict the category of insurance claim eligible for, repair time and costs for fixing the damage. On the fraud detection front, the system can detect prior usage of the same image, either by the claimant or by someone else. The system can use any convenient way to capture images using a controlled mechanism. For instance, the system can function as an application on a computing device such as a laptop or a mobile phone, directing the car user to capture images of a damaged car in a stipulated fashion.

The system provides a structured methodology to collect the images of damaged cars from the car owner and to predict, using historical insurance claim data, the payout to be borne by the insurer. The system trains the CNN is trained to handle fine-grained parts localization and anomaly detection. Based on previous data, the model can help the insurer and the insured predict the category of insurance claim eligible for, repair time and costs for fixing the damage. On the fraud detection front, the AI brings in the capability to check whether the image belongs to the insured car or not. The AI can also detect prior usage of the same image, either by the claimant or by others.

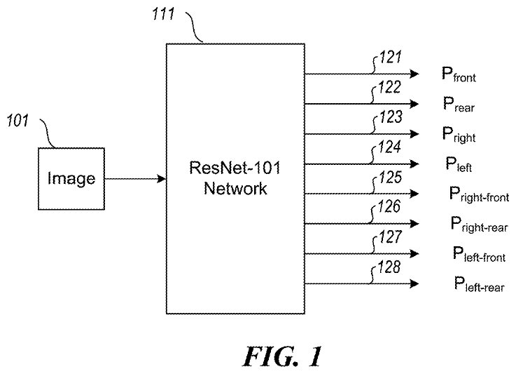

FIG. 1 is a data flow diagram showing data flow for the system's first stage in which the system uses a neural network to classify images of the damaged car as each portraying a particular region of the car. The system submits each car image 101 to a region classification neural network 111, such as a CNN, trained by the system. The network responds by identifying a car region portrayed in the photograph among car regions 121-128. Region 121 is the front of the car; region 122 is the rear of the car; region 123 is the right side of the car; region 124 is the left side of the car; region 125 is the right-front quarter panel; region 126 is the right-rear quarter panel; region 127 is the left-front quarter panel; and region 128 is the left-rear quarter panel.

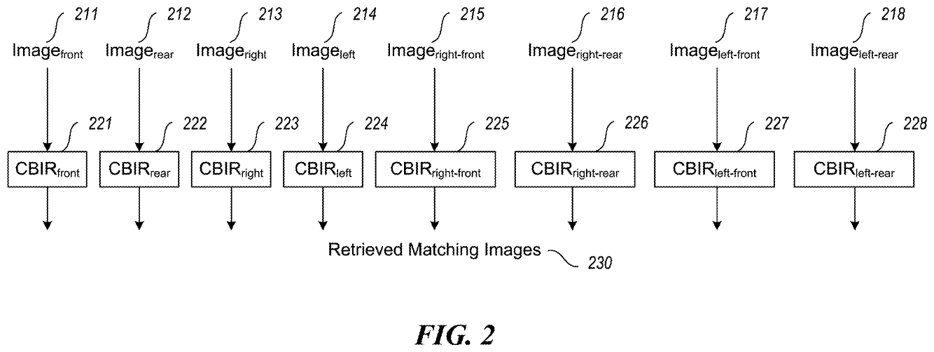

FIG. 2 is a data flow diagram showing data flow for the system's second stage in which the system uses CBIR tools trained by the system to analyze damage to each region by matching it to sample damage of known magnitude and cost to the same region of other cars. In particular, the system creates CBIR tools 221-228 each for matching images of damage to a particular one of the regions of the subject car with the most visually similar images of damage to the same region and other cars where the extent and cost of the damage is known. For example, CBIR tool 228 matches images of damage to the left-rear quarter panel of the subject car with the most visually similar images of damage to the left-rear quarter panel of other cars were the extent and cost of the damage is known. In some embodiments, the system creates the CBIR tools using damage photos and corresponding damage cost assessments from earlier claims. To obtain a total damage cost assessment for the subject car, the system aggregates damage cost information from the matching images 230 retrieved by the CBIR tools as most closely matching the images of the subject car. In some embodiments, the system performs inflation adjustment to the damage cost information for the matching images based upon the dates on which the corresponding claims were submitted. In various embodiments, the system displays or prints its total damage cost assessment; recommends payment of the claim on the subject car for this amount; and/or itself approves payment of the claim on the subject car for this amount.

The system can use any device with a camera and a display such as a tablet, laptop, smartphone or a custom-built device which serves as a tool to record and transmit the images to the server for insurance claim evaluation.

For the task of region classification, in some embodiments, the system uses RESNET-101 Architecture. RESNET, meaning Residual Network, is a convolution neural network architecture with shortcut connections, described in K. He, X. Zhang, S. Ren and J. Sun, “Deep Residual Learning for Image Recognition,” 2016 IEEE Conference on Computer Vision and Pattern Recognition (CVPR), Las Vegas, N V, 2016, pp. 770-778, to overcome the problem of vanishing gradients in normal plain deeper CNNs. This document is hereby incorporated by reference in its entirety.

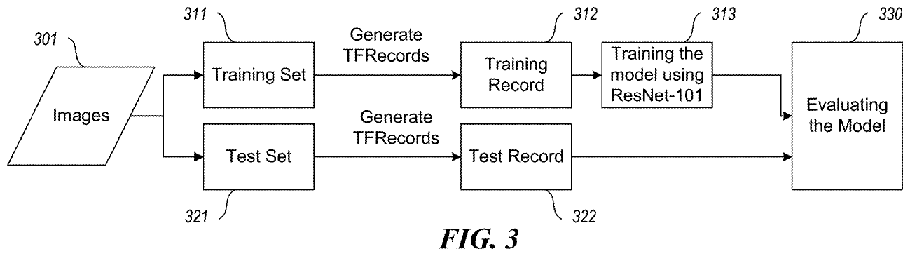

FIG. 3 is a data flow diagram illustrating a process performed by the system in some embodiments to perform car region classification for car images. Using past images 301 along with the ground truth (not shown), the RESNET classifies an input image into one of the eight possible regions. The system splits the dataset into a training set 311 and a test set 321 generating training records 312 and test records 322, respectively. The system then trains 313 the model using the RESNET-101 network. The system validates the model using the test set, after which it is available for evaluation 330.

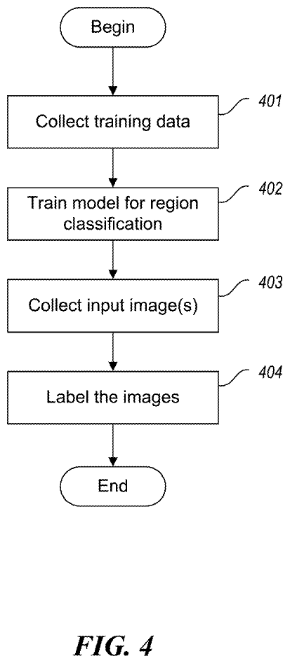

FIG. 4 is a flow diagram showing process performed by the system in some embodiments to perform region classification. In act 401, the system collects training data. In act 402, the system uses the collected training data to train the, the facility collects input images for the subject car. In act 404, the facility applies the trained model to label each input image with a car region classification. After act 404, this process concludes.

For the task of predicting the insurance amount to be approved for the claim, the system uses a content-based image retrieval (CBIR)-based system. CBIR is an image querying technique from a large image database.

Image retrieval techniques retrieve images given a query image; “content-based” refers to retrieval of images based on the content of the query image. The aim of CBIR is to search for images by analyzing their visual content. Thus, image representation forms the crux of CBIR. In traditional CBIR systems, a variety of low-level feature descriptors have been proposed for image representation: for example, global features such as color features, edge features and texture features, as well as local features such as forming a bag of words using Scale Invariant Feature Transform (SIFT) and Speeded-up Robust Features (SURF). An inherent weakness of traditional CBIR systems is that they cannot capture high-level concepts. In some embodiments, therefore, the system uses a deep learning based CBIR system for better image representation. Deep learning allows for fast lookup of various kinds of candidates by encoding them. In some embodiments, the system uses deep autoencoders to encode and decode images. Autoencoders can then map images to short vectors and these vectors have a compact representation and also capture high level concepts and are thus suitable for image retrieval as a basis for looking them up in the CBIR tools created by the system.

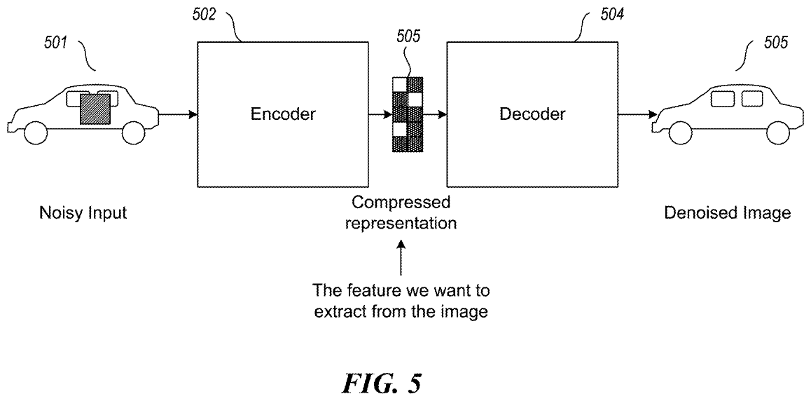

FIG. 5 is a data flow diagram showing the system's application of deep autoencoders in some embodiments. The system applies encoder 502 to noisy image input 501 to obtain a compressed representation 503 of the input image, which constitutes the feature extracted from the input image. The system applies decoder 504 to the compressed representation to obtain version 505 of the input image.

CBIR searches the contents of an image by analyzing the color, shape (of the region), texture along with the high-level concepts. In some embodiments, the system constructs and uses eight CBIR search systems, one for each of the eight regions specified in the first stage of the methodology.

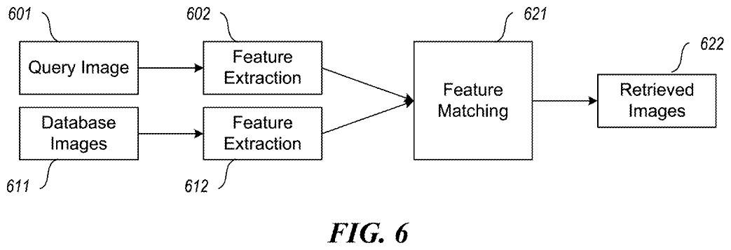

FIG. 6 is a data flow diagram showing the system's retrieval in some embodiments of matching car images using a CBIR tool. The system feeds the query image 601, classified into one of the eight regions, into the CBIR search tool corresponding system. The system has a stored feature vector for each image in the database 611. Upon receiving a query image, the system generates 602 a feature vector for the image and does similarity matching 621 with its feature vector database 612. Finally, the system outputs the combined vector which most closely matches the one that was fed into the system. The system then retrieves 622 the corresponding insurance amount that was paid in the past for the respective match, and calculates the inflation-adjusted amount to find the amount to be paid by the insurer for the present claim.

In some embodiments, images of a damaged car are taken by the insured person via a mobile application. The images are then transferred to the insurer's server which hosts the model. The model then automatically does the damage assessment.

In some embodiments, in the deep learning system, the modeling is based on individual car parts, such as the windscreen, bumper, rear-view mirror, etc. A dataset is built comprising images of particular car parts and the percentage of damage within the same. Given an input image of a damaged car, the model learns to isolate individual car parts in the image with a bounding box, and classify the level of damage for each part into pre-specified buckets. Thus, this becomes a problem of classification. The level of damage of all parts can be aggregated to determine the overall damage in the car.

The described system for car damage assessment can be straightforwardly repurposed for other vehicle insurance categories such as motorcycles, vans, or planes.

Vehicle maintenance is another area to which this system can be applied. A pre-trained model can help to evaluate the extent of damage in a vehicle or to identify potential areas requiring some sort of maintenance. A specific example is for aircraft maintenance. Using drone imaging, images of the aircraft can be captured. The system can then be used to evaluate wear and tear in flight parts, reducing the need for direct manual inspection.

In some embodiments, the system finds defects in manufactured goods. Manual inspection of these goods gives room for the possibility of a defect to go undetected. Introducing AI for inspection of goods has a significant impact on quality assurance in factories and also increases the output at the shop floor.

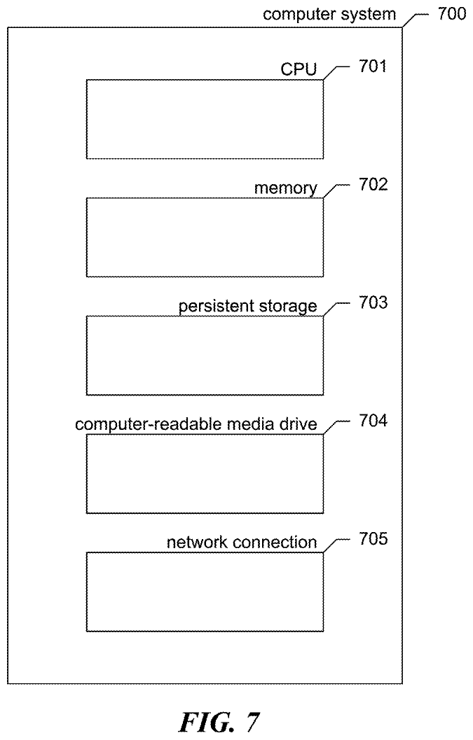

FIG. 7 is a block diagram showing some of the components typically incorporated in at least some of the computer systems and other devices on which the system operates. In various embodiments, these computer systems and other devices 700 can include server computer systems, desktop computer systems, laptop computer systems, netbooks, tablets, mobile phones, personal digital assistants, televisions, cameras, automobile computers, electronic media players, smart watches and other wearable computing devices, etc. In various embodiments, the computer systems and devices include one or more of each of the following: a central processing unit (“CPU”), graphics processing unit (“GPU”), or other processor 701 for executing computer programs; a computer memory 702 for storing programs and data while they are being used, including the facility and associated data, an operating system including a kernel, and device drivers; a persistent storage device 703, such as a hard drive or flash drive for persistently storing programs and data; a computer-readable media drive 704, such as a floppy, CD-ROM, or DVD drive, for reading programs and data stored on a computer-readable medium; and a network connection 705 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components. In various embodiments, the computing system or other device also has some or all of the following hardware components: a display usable to present visual information to a user; one or more touchscreen sensors arranged with the display to detect a user's touch interactions with the display; a pointing device such as a mouse, trackpad, or trackball that can be used by a user to perform gestures and/or interactions with displayed visual content; an image sensor, light sensor, and/or proximity sensor that can be used to detect a user's gestures performed nearby the device; and a battery or other self-contained source of electrical energy that enables the device to operate while in motion, or while otherwise not connected to an external source of electrical energy.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A method in a computing system, comprising:
receiving photos in connection with a distinguished auto insurance claim;
for each of the photos:
using a statistical model to identify a portion of the automobile shown in the identified region;
applying to the photo one of a plurality of content-based retrieval systems that is specific to the identified automobile portion to retrieve one or more similar photos submitted with resolved claims that show the identified region of an automobile that is the subject of the claim; and
for each retrieved photo, accessing a quantitative measure describing repair work performed under the resolved claim with which the retrieved photo was submitted;
aggregating some or all of the accessed quantitative measures to obtain a quantitative measure predicted for the distinguished claim; and
outputting the obtained quantitative measure predicted for the distinguished claim.

2. The method of claim 1 wherein the obtained and outputted quantitative measure is appropriate category of insurance claim.

3. The method of claim 1 wherein the obtained and outputted quantitative measure is time to repair.

4. The method of claim 1 wherein the obtained and outputted quantitative measure is cost to repair.

5. The method of claim 1, further comprising training the statistical model.

6. The method of claim 1, further comprising training each of the content-based retrieval systems.

7. The method of claim 1 wherein the statistical model is a convolutional neural network.

8. The method of claim 1 wherein the content-based retrieval systems are implemented using autoencoders.

9. One or more memories collectively storing a vehicle damage assessment model data structure, the data structure comprising:
for each of a plurality of vehicle regions:
a content-based retrieval system configured to retrieve, for a subject image showing the vehicle region of the subject vehicle, one or more similar images among images of the vehicle region of damaged observation vehicles; and
for each of the images of the vehicle region of damaged observation vehicles, an indication of an actual repair cost incurred for damage shown in the image, such that, for a distinguished subject image showing damage to a distinguished vehicle region of a distinguished subject vehicle,
the content-based retrieval system for the distinguished vehicle region can be used to retrieve one or more similar images of the vehicle region of damaged observation vehicles,
and the indication of an actual repair cost incurred for damage shown in the retrieved image or images can be aggregated to estimate a repair cost for the damage to the distinguished vehicle region of the distinguished subject vehicle.

10. The one or more memories of claim 9 wherein the content-based retrieval systems are implemented using autoencoders.

11. The one or more memories of claim 9, the data structure further comprising:
a classification model trained to classify a subject image of a vehicle as showing a vehicle region among a plurality of vehicle regions, such that the classification model can be applied to the distinguished subject image to identify the distinguished vehicle region.

12. The one or more memories of claim 11 wherein the classification model is a convolutional neural network.

13. One or more memories collectively having contents configured to cause a computing system to perform a method, the method comprising:
receiving one or more photos in connection with a distinguished auto insurance claim;
for each photo:
using a statistical model to identify a portion of the automobile shown in the identified region;
applying to the photo one of a plurality of content-based retrieval systems that is specific to the identified automobile portion to retrieve one or more similar photos submitted with resolved claims that show the identified region of an automobile that is the subject of the claim; and
for each retrieved photo, accessing a quantitative measure describing repair work performed under the resolved claim with which the retrieved photo was submitted;
aggregating some or all of the accessed quantitative measures to obtain a quantitative measure predicted for the distinguished claim; and
outputting the obtained quantitative measure predicted for the distinguished claim.

14. The one or more memories of claim 13 wherein the obtained and outputted quantitative measure is appropriate category of insurance claim.

15. The one or more memories of claim 13 wherein the obtained and outputted quantitative measure is time to repair.

16. The one or more memories of claim 13 wherein the obtained and outputted quantitative measure is cost to repair.

17. The one or more memories of claim 13, further comprising training the statistical model.

18. The one or more memories of claim 13, further comprising training each of the content-based retrieval systems.

19. The one or more memories of claim 13 wherein the statistical model is a convolutional neural network.

20. The one or more memories of claim 13 wherein the content-based retrieval systems are implemented using autoencoders.
